(19) United States
(12) Patent Application Publication
(10) Pub. No.: US 2007/0029419 A1
(43) Pub. Date: Feb. 8, 2007

(54) Method for Gathering, Segregating, and Processing Specification Raw Materials

(76) Inventor: Mark A. Dupuis, Westfield, MA (US)

Correspondence Address: DOHERTY, WALLACE, PILLSBURY & MURPHY, P.C., ONE MONARCH PLACE, SUITE 1900, 1414 MAIN STREET, SPRINGFIELD, MA, 01144-1900, US

(21) Appl. No.: 11/461,854

(22) Filed: Aug. 2, 2006

Related U.S. Application Data
(60) Provisional application No. 60/595,792, filed on Aug. 5, 2005.

(51) Int. Cl. B02C 17/00

(52) U.S. Cl. 241/24.1; 44/590

(57) ABSTRACT

A method for conducting business comprising: segregating refuse materials into types, wherein one of the types comprises specification raw materials; processing the specification raw materials into a fuel source; and utilizing the fuel source to create power.

### CROSS REFERENCE TO RELATED APPLICATIONS

This application claims the benefit of U.S. Provisional Application No. 60/595,792 filed on Aug. 5, 2005.

### BACKGROUND OF THE INVENTION

1. Field of the Invention

The present invention relates generally to a method for conducting business. More specifically, the present invention relates to a method for gathering, segregating, and processing specification raw materials for use as a fuel source.

2. Background of the Invention

Utilizing non-recyclable raw materials in the generation of fuel is known. However, problems inherent in the usage of non-recyclable raw materials as a fuel source include insufficient segregation of the fuel source resulting in contamination of the fuel source, economic loss in the inefficient utilization of the fuel source, inefficient processing of the fuel source prior to the receipt of the fuel source by the fuel generating facility, an insufficient storage capacity of the fuel generating facility such that the fuel source cannot be properly stored at the fuel generating facility, and an insufficient system for converting the fuel source to a form that can be suspended when blown into a burner, boiler, furnace, and the like.

Through regulations promulgated by the United States Environmental Protection Agency and by various state environmental protection agencies, the removal of hazardous materials from manufacturing has created materials that are basically purified forms of wood fiber, organic fiber and materials, and petroleum products that are free of heavy metals and other hazardous materials. This, combined with the huge increase in demand for paper-based products, has created a dramatic excess supply of renewable, non-recyclable biomass raw materials potentially well suited for use as a fuel source. Accordingly, what is needed is a method that can utilize this non-recyclable biomass in an efficient, economical, profitable, and environmentally friendly manner.

### SUMMARY OF THE INVENTION

The present invention is directed to a method for conducting business, wherein such method comprises: segregating specification raw materials, which comprise materials essentially lacking in heavy metals and other hazardous materials, through a specific segregation process, wherein the segregation process separates out and stores the specification raw materials in a designated container utilizing a specialized container system; transporting the segregated specification raw materials, preferably from a source facility, to a fuel processing site; and processing the specification raw materials to create a storable fuel source. The invention further comprises transporting the storable fuel source derived from the SRMs utilizing a specific system of transportation, and processing and using the storable fuel source for combustion at a fuel generating facility.

### BRIEF DESCRIPTION OF THE DRAWINGS

FIG. 1 is a schematic of a flowchart charting an exemplary inventive method.

### DETAILED DESCRIPTION OF THE INVENTION

In general, disclosed herein is a method for doing business comprising, gathering, segregating, purchasing and acquiring specification raw materials (“SRMs”) for the manufacture of a zero mercury, low sulfur, low nitrogen, low moisture, biomass fuel source, processing the SRMs for use as a fuel source, and delivering the fuel source to a fuel generating facility where it is used to generate power. As used herein and throughout, “fuel generating facility” refers to a power plant or to any facility where fuel is combusted, burned, or otherwise processed to generate fuel, wherein such combustion, burning, and the like may occur in a combustion chamber or other fuel producing member.

The SRMs may come from a variety of sources, and may include, without limitation, non-recyclable, high purity, non-hazardous scrap, trim, surplus, off-specification, and related materials purchased or otherwise acquired from industrial, commercial, and residential sectors. The SRMs used to form the fuel source may comprise any inorganic or organic materials comprised of, for example, virgin, pre-consumer, post-consumer, screened, classified and unclassified material extracted from municipal solid waste (MSW) streams, and material from MSW and non-MSW streams, scrap material and by-products from manufacturing processes. In an exemplary embodiment, the SRMs comprise non-recyclable materials, which may comprise, for example, paper, coated paper, laminated paper, waxed paper, fiber, textiles, fabrics, cardboard, chip-board, short fiber; non-halogenated plastics; polymers; milk containers; oil bottles; waxed fossil fuels; oil; grease; animal derived fats; stumps; yard debris; trimmings; clean unpainted or untreated lumber ends; wood pallets; wood chips; shavings; slash and other clean lumber; agricultural waste; food material and vegetative materials; energy crops; classified materials from material recycling facilities; and other refuse derived fuels that are collected and managed separately from municipal solid waste. The majority of these fuel sources comprise non-recyclable purified forms of organic fuel sources and fossil fuels.

The method is now more particularly described below.

A. Gathering Refuse Materials.

The inventive method comprises gathering refuse material at a source facility, i.e., the facility where the refuse originates and/or accumulates, whether it be an industrial facility, a commercial facility, or a transfer station such as would apply for the accumulation of residential refuse, for example. The source facility is also referred to herein as the SRMs supplier. A “transfer station” is defined as an intermediate facility in which loads from waste collection vehicles are combined into larger loads for hauling to a landfill. Where the refuse originates from residential areas, municipally employed trash collectors may be contracted with to transfer the refuse to a transfer station where the refuse material can be segregated as discussed below.

B. Segregating the SRMs From the Refuse Material.

The inventive method further comprises segregating the refuse material according to the refuse material's classification, wherein such segregation may be conducted manually or by machine. The refuse materials are classified according to type, wherein the various types include, SRMs, recyclable materials, and waste materials, wherein waste materials comprise, for example, food matter, non-recyclables, non-SRMs, and the like.

The inventive method requires proper segregation of SRMs out of the waste stream to reduce the likelihood of contaminating the SRMs with non-viable fuel generating materials. Accordingly, it is imperative that those materials that are unsuitable for use as a fuel source, i.e., recyclable materials and waste materials, be separated from the SRMs, wherein such separation or segregation is preferably conducted at the source facility, as segregation at the place of the refuse materials' origin further reduces the likelihood of cross-contamination.

In pursuit of obtaining segregated SRMs, upon classification of the refuse materials, the materials are placed into receptacles specially designed to hold a particular type of material. For example, in an exemplary embodiment, materials characterized as recyclable materials are placed into a receptacle specially designated to hold recyclable materials, materials characterized as SRMs are placed into a receptacle specially designated to hold SRMs, and materials characterized as waste materials are placed into a receptacle specially designated to hold waste materials.

The receptacles may be specially marked or otherwise identified to indicate which type of refuse materials it is to hold. Such designations of the receptacles may comprise, for example, color coding the receptacles, labeling the receptacles, providing signage in proximity to the receptacles, and the like. Additionally, each of the receptacles may be positioned within a specially designated location in the source facility to reduce the likelihood of cross-contamination among the various receptacles.

Furthermore, to ensure that the refuse materials are properly typed and segregated, the facilities at which the segregation occurs, e.g., the SRMs supplier, preferably will implement quality control programs to insure the integrity of the SRMs sold to the fuel processing site and/or fuel generating facility in the same fashion as it controls its primary products. Furthermore, one or more contamination prevention aids may be instituted at the SRMs suppliers' facilities. Such contamination prevention aids may include, for example, non-conforming materials segregation management programs, employee education training, the use of signage to remind the employees at the source facilities what types of materials are suitable and which are not, and equipment and implementation assistance on-site at the source facilities. Additionally, in order to ensure the integrity and purity of the SRMs, each source facility will preferably provide a material safety data sheet (“MSDS”) for all of the materials contained in the SRMs. That is, all of the components of the SRMs are preferably identified in the MSDS, which is then provided by the source facility to the fuel processing site.

Furthermore, a written SRMs supplier profile for each of the SRMs suppliers may be generated, updated, and used during receiving at the fuel processing site to inspect for any possible accidental contamination that may have potentially existed at the SRMs supplier's location. A signed certification from all of the SRMs suppliers is also preferably provided to guarantee that the materials sent to the fuel processing site meet the specifications criteria agreed to in the materials handling contracts which are entered into by and between the SRMs source and the fuel processing site.

Additionally, to control and to better ensure the integrity of pre-consumer and post-consumer SRMs, the source facilities preferably will be provided with segregation standards and requirements. These segregation standards may be in the form of lists and charts which specify for each SRMs supplier, individualized listings of refuse materials generated by that particular SRMs supplier, and into which containers the individual types of refuse should be placed.

Also, the SRMs suppliers may be contracted with to provide employee education and training relating to the proper segregation and containment of the various types of refuse materials. The method of education and training may comprise providing reading materials to employees and conducting conferences to explain such reading materials which will educate employees as to the reasoning behind the segregation of the SRMs out of the waste stream. Employees preferably will be informed as to the framework for the industry and its significant advantages. Additionally, employers preferably would be given guidelines as to how to categorize the various types of materials into SRMs, recyclable materials, and waste materials. Additionally, preferably, employers are provided with documentation in the form of policies to refer to in the normal course of business regarding the proper identification and segregation of SRMs.

In addition to ensuring the integrity of the SRMs, the precautions taken to ensure the purity of the fuel source yields major financial savings, e.g., a 50% reduction in costs, directly to the SRMs suppliers. This costs savings, then provides a valuable incentive to the SRMs supplier for maintaining integrity and quality control.

C. The Hauling System.

Additionally, an independent hauling system is preferably provided for the SRMs independent from the hauling systems used for the recyclable and waste materials to further reduce the likelihood of cross-contamination among the various receptacles, thereby ensuring the purity of the SRMs. Therefore, the inventive method further comprises hauling of the SRMs from the SRMs supplier to a fuel processing site where the SRMs are processed for use as a storable fuel source which is configured for easy storage and transportability to the fuel generating facility. As the inventive method contemplates that hauling will be conducted from the SRMs supplier's site to the fuel processing site, the SRMs preferably will not be transported via conventional waste haulers where the SRMs materials would be hauled simultaneously to the hauling of other refuse materials, but rather, will be hauled separately from other types of refuse materials. Hauling in the inventive fashion, then, maintains the segregation standards and prevents contamination of the SRMs with foreign materials. In an exemplary embodiment, contracts between the fuel processing site and the waste haulers may be entered into, whereby the fuel processing site facility will offer to haul materials for the waste haulers. Additionally, contracts for the purchase and sale of the SRMs may be entered into by and between the SRMs suppliers and the fuel processing site.

D. Processing the SRMs.

Once the SRMs are transported to and received by the fuel processing site, the SRMs are processed such that they are configured to be easily storable and transportable. In an exemplary embodiment, the SRMs are densified into a compact form via a densification assembly. The densification assembly comprises a plurality of machines that prepare the SRMs for delivery to a fuel generating facility, and places the SRMs into a configuration which allows for the easy storage of the SRMs at the fuel generating facility. More particularly, the densification assembly shreds the SRMs into strips, and pelletizes the strips into a plurality of densified fuel source elements, wherein the strips are preferably densified into an easily transportable form, such as, for example, a plurality of cubed SRMs, and then stored in a holding area.

E. Delivering the Fuel Source Elements to a Fuel Generating Facility.

The fuel source elements are delivered from the fuel processing site to the fuel generating facility. In an exemplary embodiment, the fuel source elements are placed in the cargo portion of a truck, and delivered on site to a customer's fuel generating facility. Upon delivery, the fuel source elements can be stored on the cargo portion of the truck until needed. This delivery system, then, provides a convenient way in which to transport and to store the fuel source elements at the fuel generating facility, a plant where storage space is often a high commodity.

F. Conversion of the Fuel Source Elements.

Prior to generating fuel from the fuel source elements, the fuel source is processed into a burnable and/or a suspendable form. Where the fuel source elements have been densified according to the above disclosure, such densified fuel source elements may be dedensified via a dedensification and delivery unit (“DDU”), which may be delivered on-site to the customer's fuel generating facility. The DDU processes and dispenses the densified fuel source elements directly into a burner, boiler, furnace, or other combustion chamber in the particle size, specifications, and parameters needed to meet each customer's specific combustion requirements. There is virtually no capital cost to the fuel generating facility customer to install the DDU. The DDU can be installed within a few days without interruption or interference to the primary fuel and equipment. The process and equipment is also eliminates the need to inventory any of the densified fuel source elements on-site at the fuel generating facility customer's location as the densified fuel source elements may be dispensed directly into the DDU, such as directly from floor trailer cars. The DDU is more specifically described in U.S. patent application Ser. No. 11/160,061, which is incorporated herein by reference in its entirety.

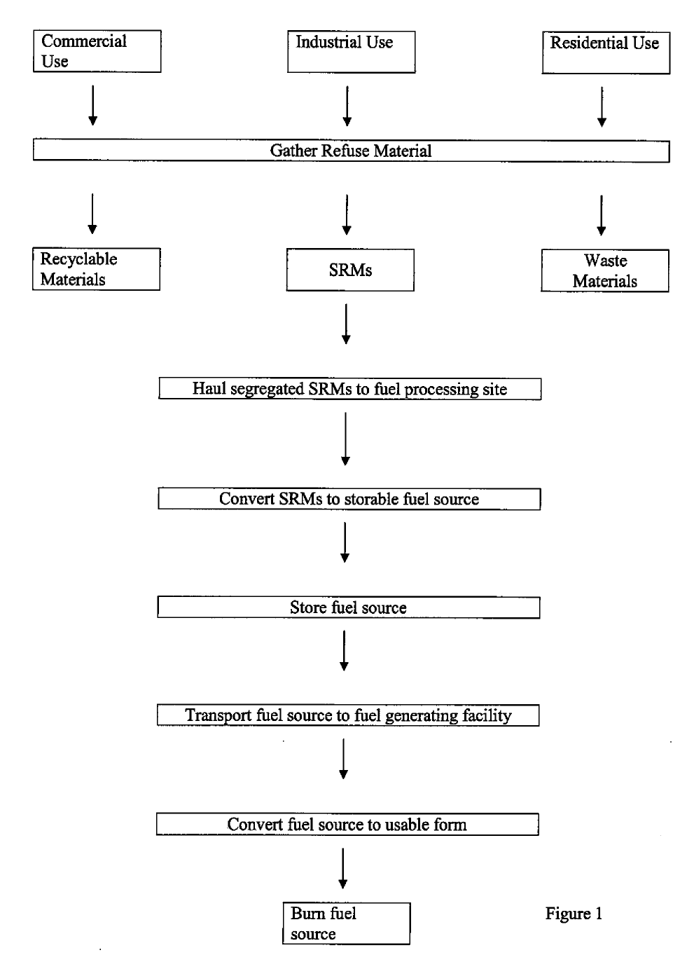

The method disclosed above is now described with reference to FIG. 1. Referring to FIG. 1, an exemplary method comprises gathering refuse materials at a source facility, wherein the refuse materials may be generated from at least one of commercial, industrial, and residential use. Once the refuse material is gathered, it is segregated according to the type of refuse material, wherein the types comprise SRMs, recyclable materials, and waste materials. The three types of materials are placed into specially designated containers. The SRMs-containing container is hauled to a fuel processing site, which will convert the SRMs to a fuel source. Such conversion is preferably accomplished via a densification assembly. The fuel source is then stored at the fuel processing site until a sufficient amount of fuel has been assembled for delivery to a fuel generating facility. Once the desired amount of fuel source has been assembled, the fuel source is transported to the fuel generating facility, where it can be stored on a transportation vehicle indefinitely. Where the fuel source is densified, it can be directly conveyed to a dedensification machine which serves to shred the densified form into pieces capable of suspension in a burner. Once in the proper form, the fuel source is placed into a burner, preferably by blowing the fuel source into the burner such that the fuel source can burn in suspension.

The fuel source generated from the SRMs obtained from the method disclosed above herein provides a cleaner burning fuel than wood, oil and coal, and, with the innovative equipment proposed herein and clean burn technology, can be burned in suspension in stoker and pulverized solid fuel boilers. Furthermore, the fuel source provides for a less complex form of fuel than either wood or coal and thus is favorable from a process kinetics standpoint.

Another advantage of the present method is that the densified fuel source is manufactured from high energy, renewable, biomass resources which otherwise would be lost. These SRMs are in most cases being land filled. Renewable Portfolio Standard is (“RPS”) eligibility is conferred for the methane gas produced from some of these same materials after they are buried. This is considered renewable biomass energy. The petroleum based materials lost from land filling SRMs is a waste of clean energy and even more valuable than the qualifying methane gas recovered through RPS qualifying generation.

Furthermore, manufacturing a densified fuel source from SRMs creates localized clean energy independence and complete materials resource life cycle management. The source is a positive economic and environmental impact for the entire business and public community. The delivered cost of the fuel source elements to the fuel generating facility is approximately 50 percent less than wood and coal on an equal British Thermal Units (“BTU”) basis.

Also by densifying the SRMs during the fuel processing stage, the resulting densified fuel source elements are capable of being indefinitely stored at the fuel processing site, and are easily transportable to the fuel generating facility. Furthermore, by allowing the densified fuel source elements to be stored on a transportation vehicle upon delivery to the fuel generating facility, rather than inside the fuel generating facility, invaluable storage space is conserved by the present method.

Add-on equipment allows the densified fuel source to be delivered and combusted in most existing solid fuel boilers. For example, the DDU “fires” the densified fuel source into existing solid fuel combustion chambers separately from the primary fuel and can achieve nearly 100% suspension burn results in pulverized coal plants and stoker plants. Each DDU delivers between about 1 to 15 tons per hour of densified fuel source elements at a higher heat value (“HHV”) of about 20,000,000 BTUs per ton. The DDU may be installed at the power generating plant locations and other combustion chambers and requires virtually no capital outlay by the plant.

Without limitation, the following provides further benefits generated by the inventive method described herein:

Manufacture of a clean, renewable, zero mercury, high energy biomass solid fuel that can dramatically reduce fuel generating facility emissions of carbon monoxide, nitrogen oxides, and sulfur dioxide.

Potential for renewable energy credits.

Localized energy independence.

Conservation of renewable and non-renewable primary fuels.

A tightly controlled fuel source stream, which can be directly contracted from the source, thereby eliminating the need for third parties or agents.

Conservation of substantial landfill space.

Cleaner air emissions from fossil fuel fired fuel generating facilities.

Quantitative control of a densified fuel source at the point of combustion, which is independent of primary fuels.

Minimal capital costs to utilities to use the fuel source.

Minimal inventorying of material or of fuel source.

Control of fuel source.

Continually reduced disposal costs to municipalities and manufacturers.

Unskilled and semi-skilled job creation.

Reduction in the amount of municipal solid waste sent to landfills.

Efficient removal of high energy, non-recyclable SRMs from the disposal stream and achievement of about an overall 40-50 percent reduction of materials deposited in landfills. Concurrently, create a significant avoided cost for disposal among manufacturing and commercial employers.

The provision of a high volume solid fuel manufacturing capability.

Other objects and advantages of the present invention will become obvious to persons of ordinary skill in the art, and it is intended that these objects and advantages be within the scope of the present invention. To the accomplishment of the above and related objects, the invention may be embodied in the form described or in obvious modifications thereto.

What is claimed is:

1. A method for conducting business comprising:
segregating refuse materials into types, wherein one of the types comprises specification raw materials;
processing the specification raw materials into a fuel source; and
utilizing the fuel source to create power.

2. The method of claim 1, further comprising placing the specification raw materials into a container specially designated to hold the specification raw materials.

3. The method of claim 2, wherein the types further comprise recyclable materials and waste materials, and wherein the method further comprises segregating and placing the recyclable materials into a specially designated recyclable material holding container and segregating and placing the waste materials into a specially designated waste material holding container.

4. The method of claim 2, wherein the segregating and placing occurs at a source facility, wherein the source facility includes a commercial site or an industrial site where the refuse materials are formed, and further includes a transfer station.

5. The method of claim 4, further comprising hauling the specification raw materials from the source facility to a fuel processing site where the processing the specification raw materials into a fuel source occurs.

6. The method of claim 5, wherein the specification raw materials are processed into a storable and transportable fuel source.

7. The method of claim 6, wherein the processing the specification raw materials into a storable and transportable fuel source comprises shredding the specification raw materials into strips, and pelletizing the strips into a plurality of densified fuel source elements.

8. The method of claim 7, further comprising holding the densified fuel source elements in a holding area at the fuel processing site.

9. The method of claim 7, further comprising transporting the densified fuel source elements to a fuel generating facility.

10. The method of claim 7, wherein utilizing the fuel source to create power comprises dedensifying the densified fuel source elements, and conveying the resulting dedensified fuel source to a burner where the dedensified fuel source is burned in suspension or as a solid fuel.

11. A method for conducting business comprising:
gathering refuse materials at a source facility, wherein the refuse materials are gathered from at least one of a commercial use, an industrial use, and a residential use, wherein the source facility includes a commercial or industrial site where the refuse materials are formed, and further includes a transfer station;
segregating the refuse materials into types at the source facility, wherein the types comprise specification raw materials, recyclable materials, and waste materials;
processing the specification raw materials into a fuel source; and
utilizing the fuel source to create power.

12. The method of claim 11, wherein the source facility comprises a transfer station, and the method further comprises contracting with trash collectors to deposit the refuse materials at the transfer station.

13. The method of claim 11, wherein the method further comprises placing the specification raw materials into a container specially designated to hold the specification raw materials, placing the recyclable materials into a container specially designated to hold the recyclable materials, and placing the waste materials into a container specially designated to hold the waste materials.

14. The method of claim 13, further comprising implementing quality control programs to assist in segregating the refuse materials, wherein the quality control programs comprise at least one of employee education and training programs, non-conforming materials segregation management programs, implementation of signage indicating what specific refuse materials fall into each type of refuse material, provision of a material safety data sheet for the specification raw materials, and a provision of lists and charts which specify, for each source facility, the actual refuse materials gathered by that particular source facility, and in which container the refuse materials should be placed.

15. The method of claim 13, further comprising hauling the segregated specification raw materials to a fuel processing site where the processing the specification raw materials into a fuel source occurs.

16. The method of claim 15, further comprising contracting between the fuel processing site and waste haulers so that the specification raw materials can be hauled to the fuel processing site.

17. The method of claim 15, further comprising providing a specification raw material source facility profile for each source facility to the fuel processing site, and inspecting the specification raw materials received from the source facility for possible contamination.

18. The method of claim 15, wherein the specification raw materials are processed into a storable and transportable fuel source.

19. The method of claim 18, wherein the processing the specification raw materials into a storable and transportable fuel source comprises shredding the specification raw materials into strips, and pelletizing the strips into a plurality of densified fuel source elements.

20. The method of claim 19, further comprising transporting the densified fuel source elements to a fuel generating facility.

21. The method of claim 20, wherein utilizing the fuel source to create power comprises dedensifying the densified fuel source, and conveying the resulting dedensified fuel source to a burner where the dedensified fuel source is burned in suspension or as a solid fuel.
